(19) United States
(12) Patent Application Publication
(10) Pub. No.: US 2016/0190975 A1
(43) Pub. Date: Jun. 30, 2016

(54) CLAMP ASSEMBLY FOR SECURING PANELS TO SUBSTRATES

(71) Applicant: Sundance Renewable Solutions, Georgetown, TX (US)

(72) Inventors: David B. Scoggins, Georgetown, TX (US); Robert S. Balog, JR., College Station, TX (US)

(21) Appl. No.: 14/587,532

(22) Filed: Dec. 31, 2014

(51) Int. Cl. H02S 20/20; B25B 5/14; F16B 2/06; B25B 5/00

(52) U.S. Cl. CPC H02S 20/20; B25B 5/006; B25B 5/145; F16B 2/065

(57) ABSTRACT

An apparatus for securing a panel to a substrate includes a base member, an attachment member for securing the substrate within an opening of the base member; a clip member comprising a U-shaped member and a curve-sided member, wherein the U-shaped member includes a central portion and first and second walls defining a generally U-shaped access region for accepting the curve-sided member, wherein at least one of the first and second walls includes a longitudinal flange extending laterally outwardly from an upper end thereof, wherein each of the U-shaped member and a curved area of the curve-sided member includes a corresponding hole for accepting the attachment member therethrough, and securing member for pressing the longitudinal flange against a top edge portion of the panel, thereby securing the panel to the substrate, wherein the securing member is positioned between the angle-sided member and a top end of the attachment member.

### BACKGROUND

Unless otherwise indicated herein, the materials described in this section are not prior art to the claims in this application and are not admitted to be prior art by inclusion in this section.

Photovoltaic (PV) modules are typically configured to produce electricity most efficiently from direct sunlight. Mounting hardware for PV modules has been designed to reliably mount and expose PV modules to direct sunlight by attaching them to unobstructed buildings, vehicles, or structures. While there have been a number of recent developments in the field of building integrated PV systems, there are still issues with their installation, such as ease of orientation issues, PV module alignment issues, ventilation issues, servicing issues, and inability to work well in retrofit applications.

Numerous systems have been devised to mitigate these issues, but most have resulted in costly and cumbersome mounting hardware. One such system is disclosed in U.S. Pat. No. 6,672,018 ('018) to Shingleton. The '018 patent discloses a solar collector array formed of a plurality of solar panels mounted on a frame made of support beams that may be sheet metal channel members. A butyl tape or other glazing material is applied between the back laminate of the solar panel and the beam. Clips are used to clamp the panels to the support beams. The clips have an upper portion that is generally T-shaped in profile and a retainer in the form of a channel nut or bar, with a threaded hole that receives a bolt or similar threaded fastener. The retainer biases against the inwardly directed flanges of the channel support beam. Electrical wires and mechanical fasteners are concealed within the support beams.

Therefore, a definite need exists for a simple, cost-effective, attachment apparatus that provides the ability to secure at any angle panels to substrates while providing ease of installation, and removal from the substrates.

### SUMMARY

According to an exemplary embodiment of the present disclosure, an apparatus is provided for securing a panel, such as a PV panel, to a substrate. The apparatus includes a base member comprising a clamp, an attachment member for securing the substrate within an opening of the base member; a clip member comprising a U-shaped member and a curve-sided member, wherein the U-shaped member includes a central portion and first and second walls defining a generally U-shaped access region for accepting the curve-sided member, wherein at least one of the first and second walls includes a longitudinal flange extending laterally outwardly from an upper end thereof, wherein each of the U-shaped member and a curved area of the curve-sided member includes a corresponding hole for accepting the attachment member therethrough, and a securing member for pressing the longitudinal flange against a top edge portion of the panel, thereby securing the panel to the substrate, wherein the securing member is positioned between the angle-sided member and a top end of the attachment member, wherein while securing the panel to the substrate, the U-shaped member contacts the curved area of the curved-sided member with a leaning angle with respect to a longitudinal axis of the attachment member that matches an incline angle at which the panel is secured to the substrate.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the disclosure by way of example only and not by way of limitation.

### BRIEF DESCRIPTION OF DRAWINGS

To understand the present disclosure, it will now be described by way of example, with reference to the accompanying drawings in which:

FIG. 1 is an elevational side view of an exemplary embodiment of a clamp assembly for securing a panel to a substrate;

FIG. 2A is an exploded side view of the clamp assembly of FIG. 1;

FIG. 2B is an exploded side view of another exemplary embodiment of a clamp assembly;

FIG. 3A is a perspective view of the clamp assembly of FIG. 2A;

FIG. 3B is a perspective view of the clamp assembly of FIG. 2B;

FIG. 3C is an elevational side view of an exemplary embodiment of a clamp tip that receives a bottom end of an attachment member;

FIGS. 4A-4I illustrate side views of a plurality of exemplary embodiments of side curved members of the clamp assembly;

FIG. 5 is an exploded view of panels secured to a plurality of benches via a plurality of the apparatuses of FIG. 3B;

FIG. 6A illustrates a partial perspective view of a plurality of panels secured to a plurality of benches via a plurality of apparatuses of FIG. 3B;

FIG. 6B illustrates a partial open perspective view of the plurality of panels secured to a plurality of benches via the plurality of apparatuses of FIG. 3B;

FIG. 7 is an exploded view of a couple of panels to be secured to an arm chair via the clamp assembly of FIG. 3B;

FIG. 8A illustrates a partial perspective view of the couple of panels secured to the arm chair of FIG. 7 via the clamp assembly of FIG. 3B;

FIG. 8B illustrates a partial open perspective view of the couple of panels secured to the arm chair of FIG. 7 via the clamp assembly of FIG. 2B;

FIG. 9 is an elevational side view of an alternate embodiment of a clamp assembly for securing a panel to a substrate;

FIG. 10 is an exploded side view of the alternate embodiment of FIG. 9; and

FIG. 11 is a front view of an exemplary embodiment of a clip having only one wall extending upward; and

FIG. 12 is a side view of an exemplary embodiment of a clip having a flange that includes teeth.

### DETAILED DESCRIPTION

While the present disclosure may be embodied in various forms, there will hereinafter be described some exemplary and non-limiting embodiments, with the understanding that the present disclosure is to be considered an exemplification of the disclosure and is not intended to limit the disclosure to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

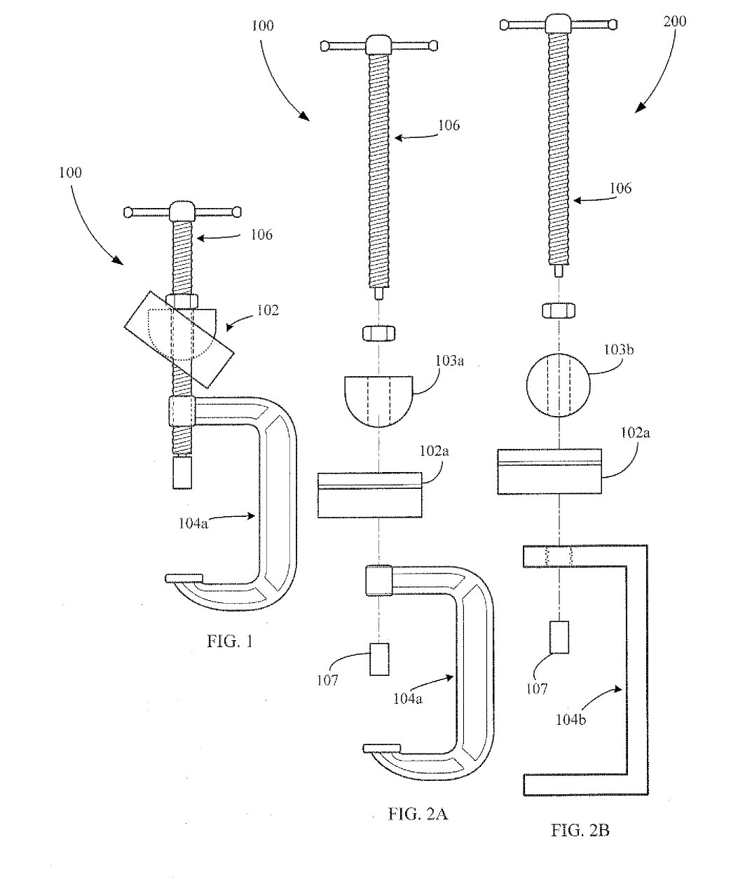

Referring to FIGS. 1-2A, there is shown an exemplary embodiment of an apparatus 100, hereafter referred to as a clamp assembly 100, for securing a panel, such as a PV panel, to a substrate. As shown, clamp assembly 100 includes a clip assembly 102 and a curved C-shaped body or frame 104a, coupled to each other through a screw or bolt 106, i.e., an attachment member. Clip assembly 102 includes clip 102a, having a generally U-shaped structure, and a curve-sided member 103a, having a longitudinal half-cylinder shape.

Referring to FIG. 2B, there is shown another exemplary embodiment of an apparatus 200, hereafter referred to as a clamp assembly 200, for securing a panel, such as a PV panel, to a substrate. As shown, clamp assembly 200 includes a clip assembly 102 and a right-angled U-shaped body or frame 104b, coupled to each other through a screw or bolt 106. Clip assembly 102 includes clip 102a and a curve-sided member 103b, having a full cylinder shape.

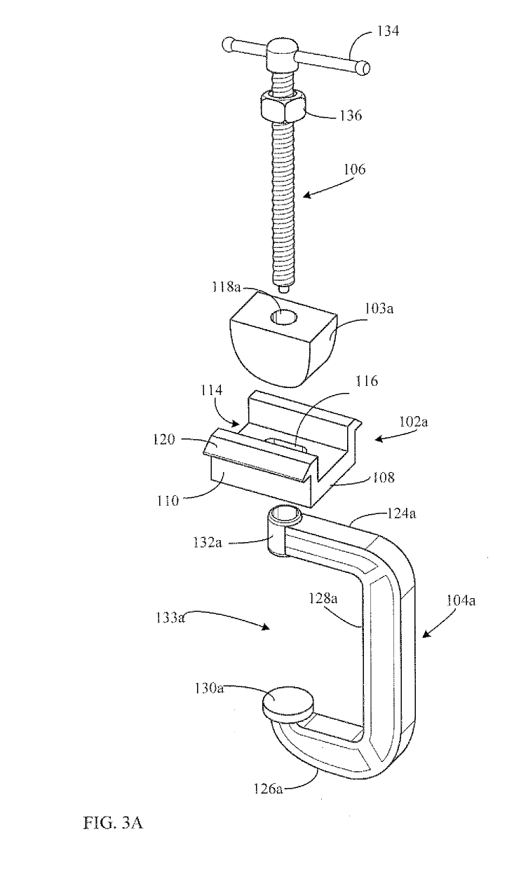

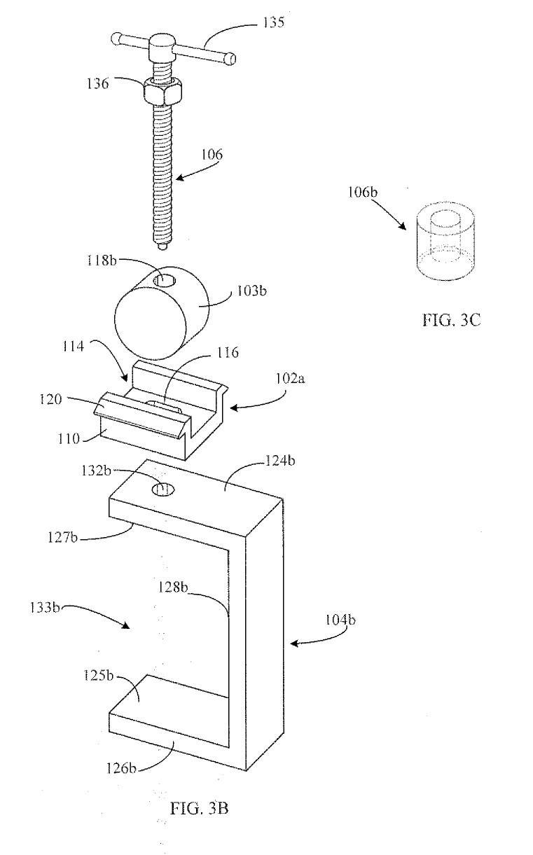

As shown in FIG. 3A, U-shaped clip 102a has a central portion 108, and a pair of raised portions or walls 110. Central portion 108 and raised walls 110 define an access region 114. Access region 114 is accessible from two (2) longitudinal sides and from above to enable unobstructed access to curve-sided members 103a-103b and to bolt 106. Raised walls 110 can be substantially perpendicular to central portion 108. Alternately, raised walls 110 can extend inwardly or outwardly over central portion 108.

As shown, central portion 108 includes a hole 116 formed therein for receipt there-through of bolt 106, and curve-sided member 103a includes a hole 118a for receipt there-through of bolt 106, thus facilitating the coupling of clip assembly 102 to C-shaped frame 104a via bolt 106. Raised walls 110 include longitudinal flanges 120 extending substantially laterally away from access region 114. Alternatively, flange 120 may be configured to extend from wall 110 in a slight downward direction, instead of forming a substantially right angle with a direction of wall 110.

C-shaped frame 104a includes a top frame portion 124a and a bottom frame portion 126a, spanned by an intermediate frame portion 128a. Bottom frame portion 126a is terminated by a bottom clamp seat 130a. Top frame portion 124a carries at its end, distant from the frame portion 128a, a threaded hole or an internally threaded housing 132a having a generally cylindrical shape. Bottom clamp seat 130a and threaded housing 132a are separated by an opening 133a, whose size is selected to be at least slightly wider than a thickness of a substrate to which a panel is to be secured.

A cross-handle 134 is slideably mounted in a transverse bore through the top end of bolt 106, and a nut 136 is threaded on bolt 106 to be positioned between the curve-sided member 103a, positioned within access region 114 of U-shaped clip 102a. During operation, elongated bolt 106 can adjustably penetrate through internally threaded housing 132a to press an object, such as a substrate, via a bottom end of bolt 106 against bottom clamp seat 130. In one exemplary embodiment of the present disclosure, bottom end of bolt 106 may be fitted into a synthetic tip 106b, shown in FIG. 3C, to enhance an effective securing of a substrate within C-shaped frame 104a.

As shown in FIG. 3B, curve-sided member 103b includes a hole 118b for receipt there-through of bolt 106, thus facilitating the coupling of clip assembly 102 to right-angled U-shaped frame 104b via bolt 106.

Right-angled U-shaped frame 104b includes a top frame portion 124b and a bottom frame portion 126b, spanned by an intermediate frame portion 128b. Top frame portion 124b includes near its end, distant from the frame portion 128b, a threaded through-hole 132b. A bottom end surface 127b of top frame portion 124b and a top end surface 125b of bottom frame portion 126b are separated by an opening 133b, whose size is selected to be at least slightly wider than a thickness of a substrate to which a panel is to be secured.

During operation, elongated bolt 106 can adjustably penetrate through internally threaded housing 132b to press an object, such as a substrate, via a bottom end of bolt 106 against top end surface 125b of bottom frame portion 126b.

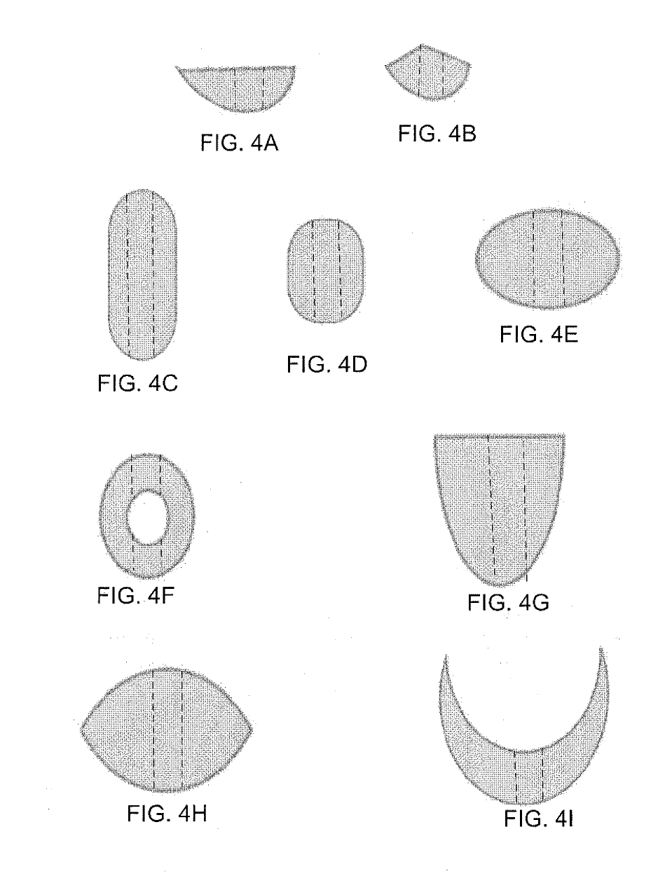

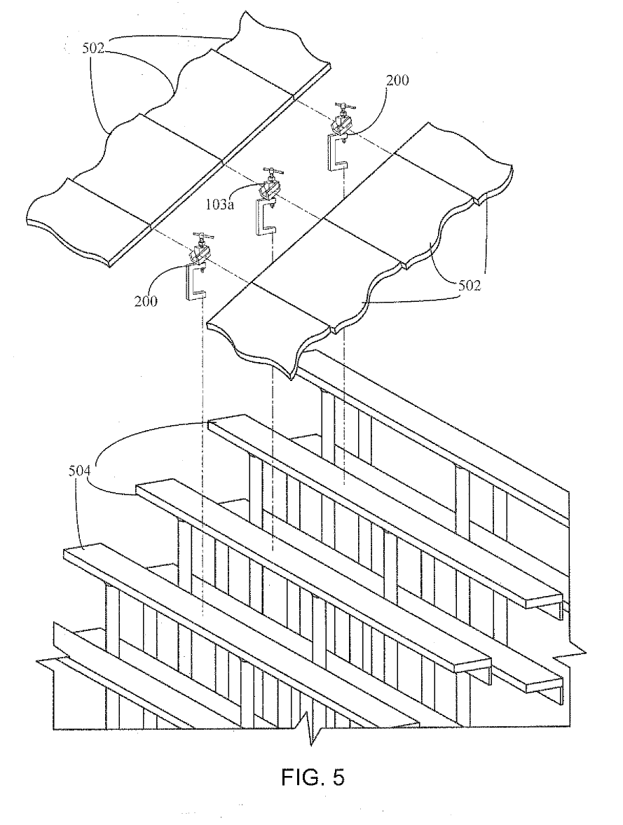

FIGS. 4A-4J illustrate side views of a plurality of exemplary curve-sided members of the clamp assembly. In addition to full-circle and half-circle cross-sectional shapes shown in FIGS. 3A and 3B, the curve-sided member may have a less than half-circle cross-sectional shape, as shown in FIG. 4A, a circular sectorial cross-sectional shape, as shown in FIG. 4B, a stadium cross-sectional shape, as shown in FIG. 4C, a general oval cross-sectional shape, as shown in FIG. 4D, an ellipse cross-sectional shape, as shown in FIG. 4E, an annulus cross-sectional shape, as shown in FIG. 4F, an arch cross-sectional shape, as shown in FIG. 4G, a lens cross-sectional shape, as shown in FIG. 4H, and a crescent cross-sectional shape, as shown in FIG. 4I.

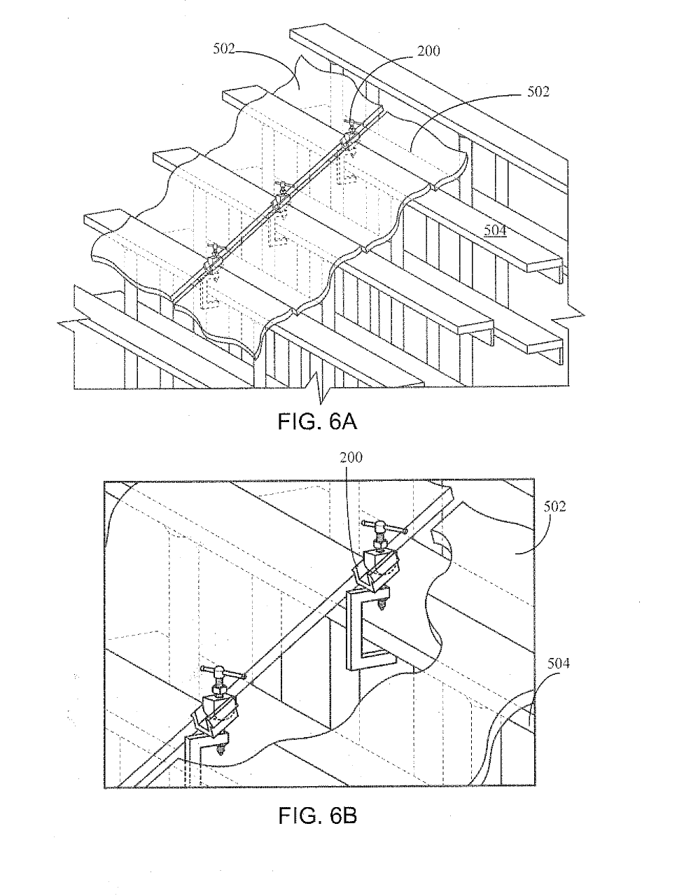

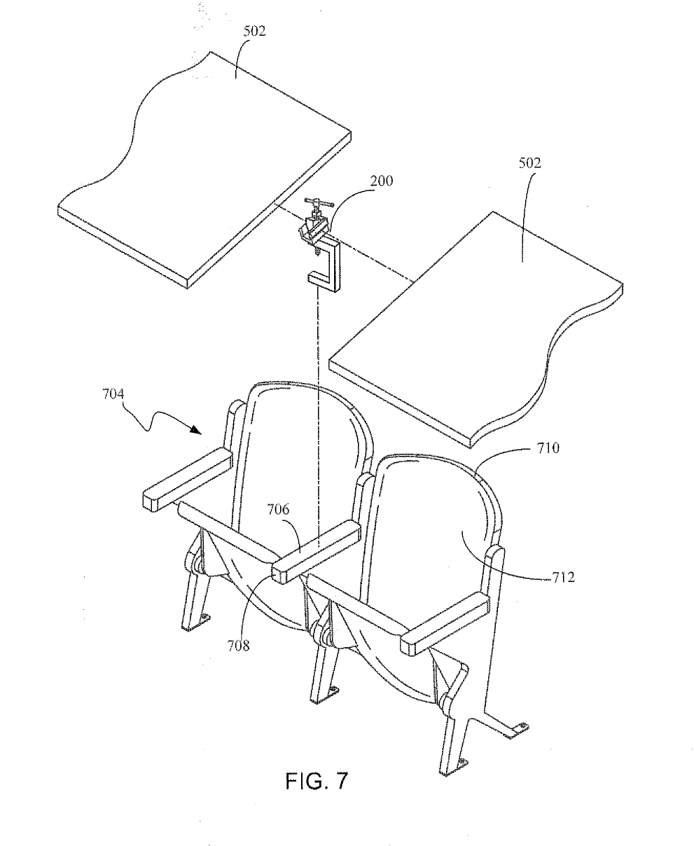

Now referring to FIGS. 5, 6A and 6B, a plurality of clamp assemblies 200 are used to secure a plurality of panels 502 to a plurality of benches or seating substrates 504. As best seen in FIGS. 6A and 6B, right-angled U-shaped frames 104b and bolts 106 are used to securely affix the corresponding assemblies 200 to benches 504. By tightening nuts 136, clip assemblies 102 are biased, via flanges 120, against top ends or edges of panels 502 while bottom surfaces of panels 502 are pressed against benches 504. While securing a panel 502 to a bench 504 with clip assembly 102, U-shaped clip 102a is configured to pivot around a longitudinal axis of bolt 106 while contacting a curved area of curve-sided member 103a, and stop pivoting along a tangent line that matches an incline angle of the bench 504 to which the assembly 200 is to be secured.

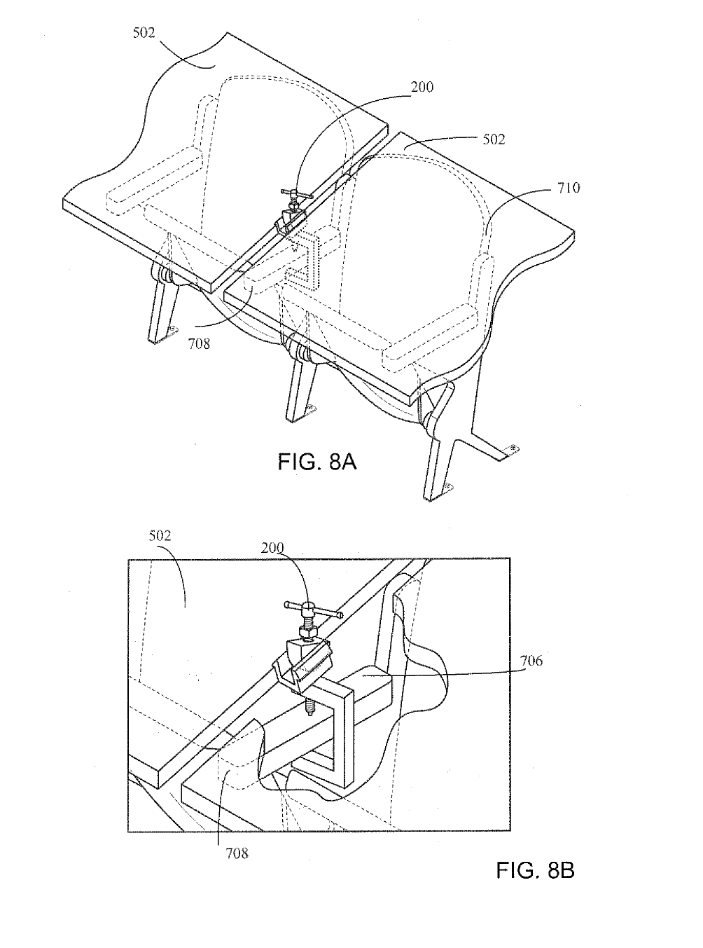

Now referring to FIGS. 7, 8A and 8B, assembly 200 is used to secure a couple of panels 502 to a couple of adjacent seats 704. As best seen in FIGS. 8A and 8B, right-angled U-shaped frame 104b and bolt 106 are used to securely affix assembly 200 to a seat arm 706 separating adjacent seats 704. By tightening corresponding nuts 136, clip assemblies 102 are biased, via flanges 120, against top ends or edges of panels 502, while bottom surfaces of panels 502 are pressed against both a forward edge 708 of seat arm 706 and a top end 710 of a seat back 712. During the tightening of nuts 136, curve-sided members 103a enable corresponding U-shaped clip 102a to pivot to an angle that matches a vertical angle formed by an oblique straight line connecting forward edges of arm 706 and top end 710 and a horizontal line sharing a vertical plane with the oblique straight line.

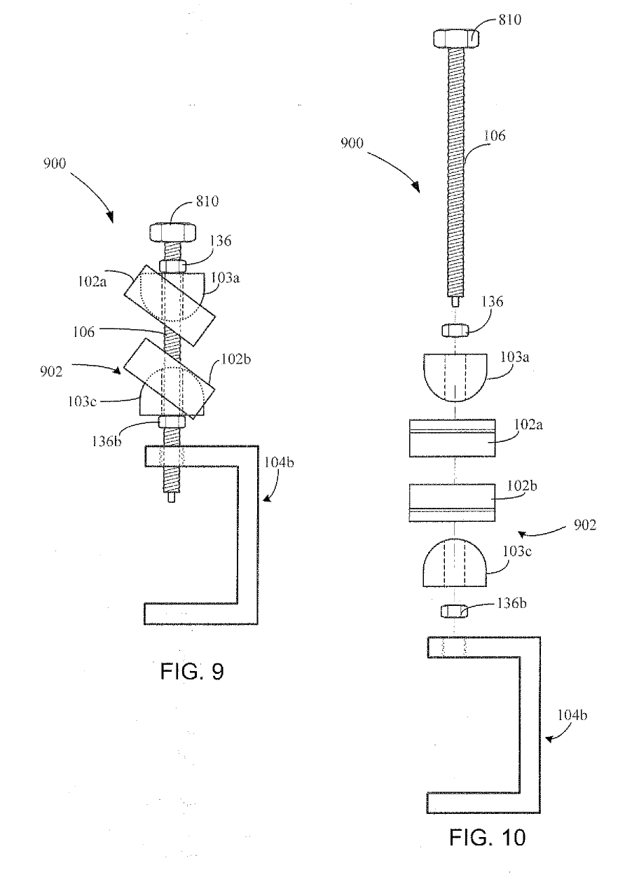

Now referring to FIGS. 9 and 10, an embodiment of an alternate clamp assembly 900 is shown. Clamp assembly 900 is substantially assembly 200 augmented with an additional clip assembly 902, and an additional nut 136b. When assembly 900 is used to securely affix a panel to a substrate, clip assemblies 102 and 902 are biased against top edges and bottom edges of the panel, respectively, via nuts 136 and 136b, respectively. In addition to the members of clip assembly 200, clip assembly 902 includes a clip 102b and a curve-sided member 103c. In one alternate exemplary embodiment of the present disclosure, curve-sided member 103a and curve-sided member 103c do not need to be similar members.

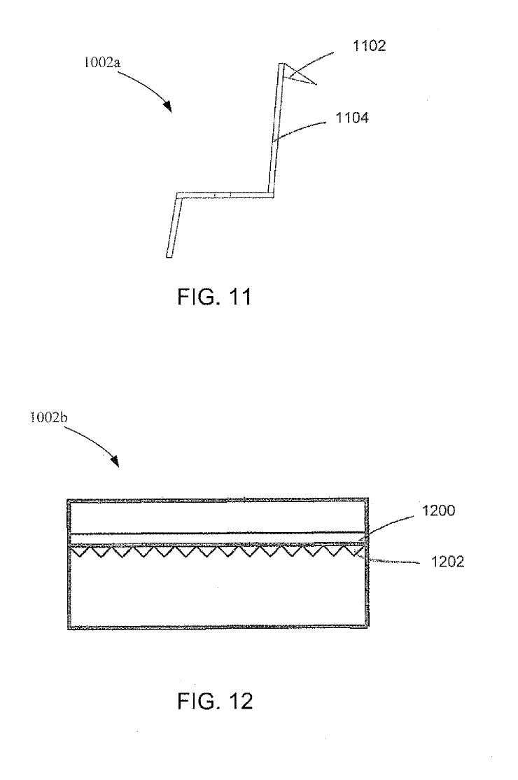

FIG. 11 is a front view of an exemplary embodiment of a clip having only one wall extending upward. As shown, unlike clip 102a, clip 1002a is configured to include only one raised wall 1104. Clip 1002a is configured to be used to secure an end/last panel to a substrate. As such, clip 1002a includes only one flange 1102 to be in contact with the end panel.

FIG. 12 is a side view of an exemplary embodiment of a clip having a flange that includes teeth. Typically, a PV panel includes a circumferential frame (not shown), having a substantially U-shaped cross-section, that surrounds it preferably from all sides. To improve the securing of the panel, flanges 120 and 1200 of clips 102a and 1002b, respectively, may include teeth 1202 that point substantially downward. As such, during the securing of clamp assembly 200 or 900 to a substrate, flanges 120 or 1200 are engaged to the circumferential frame via teeth 1202.

In another embodiment, to ensure good grounding of a PV panel, for example, each element or member of assembly 200 is formed of conductive material or at least includes or is covered with a conductive outer surface. As such, teethed clip 102a, bolt 106 and U-shaped frame 104b provide an electrical connection between a PV panel and a conductive supporting substrate, to ensure good grounding of the PV panel. Alternately, if the supporting substrate is formed of a non-conductive material, assembly 200 may be equipped with a grounding electrical wire (not shown) that may extend to a grounding element.

While certain embodiments of the present disclosure have been described, it will be appreciated that changes and modifications can be made and that other embodiments may be devised without departing from the true spirit and scope of the disclosure.

What is claimed is:

1. An apparatus for securing a panel to a substrate, comprising:
a base member comprising a clamp;
an attachment member for securing the substrate within an opening of the base member; a clip member comprising a U-shaped member and a curve-sided member, wherein the U-shaped member includes a central portion and first and second walls defining a generally U-shaped access region for accepting the curve-sided member, wherein at least one of the first and second walls includes a longitudinal flange extending laterally outwardly from an upper end thereof, wherein each of the U-shaped member and a curved area of the curve-sided member includes a corresponding hole for accepting the attachment member therethrough; and
a securing member for pressing the longitudinal flange against a top edge portion of the panel, thereby securing the panel to the substrate, wherein the securing member is positioned between the angle-sided member and a top end of the attachment member,
wherein while securing the panel to the substrate, the U-shaped member contacts the curved area of the curved-sided member with a leaning angle with respect to a longitudinal axis of the attachment member that matches an incline angle at which the panel is secured to the substrate.

2. The apparatus of claim 1, wherein the clamp comprises a right-angle U-shape frame.

3. The apparatus of claim 1, wherein the clamp comprises a C-shape frame.

4. The apparatus of claim 2, wherein the right-angle U-shape frame includes a threaded through hole at an upper end portion, and wherein the attachment member is an elongated bolt that is configured to penetrate the threaded through hole to press the substrate against a lower end portion of the base member.

5. The apparatus of claim 3, wherein the C-shape frame includes a threaded housing at an upper end portion, and wherein the attachment member is an elongated bolt that is configured to penetrate the threaded portion to press the substrate against a lower end portion of the base member.

6. The apparatus of claim 1, wherein the curve-sided member includes a half-circle cross-sectional shape.

7. The apparatus of claim 1, wherein the curve-sided member includes a full-circle cross-sectional shape.

8. The apparatus of claim 1, wherein the curve-sided member includes a greater or less than half-circle cross-sectional shape.

9. The apparatus of claim 1, wherein the curve-sided member includes a circular sectorial cross-sectional shape.

10. The apparatus of claim 1, wherein the curve-sided member includes a stadium cross-sectional shape.

11. The apparatus of claim 1, wherein the curve-sided member includes an oval cross-sectional shape.

12. The apparatus of claim 1, wherein the curve-sided member includes an ellipse cross-sectional shape.

13. The apparatus of claim 1, wherein the curve-sided member includes an annulus cross-sectional shape.

14. The apparatus of claim 1, wherein the curve-sided member includes an arch cross-sectional shape.

15. The apparatus of claim 1, wherein the curve-sided member includes a lens cross-sectional shape.

16. The apparatus of claim 1, wherein the curve-sided member includes a crescent cross-sectional shape.

17. The apparatus of claim 1, wherein the attachment member comprises a bolt having a cross-handle slideably mounted in a traverse bore through the top end of the attachment member.

18. The apparatus of claim 1, wherein the securing member is a nut used to bias the clip member via the longitudinal flange against the top edge portion of the panel.

19. The apparatus of claim 1, further comprising a second clip member having a second U-shaped member, a second curve-sided member, and a second securing member, wherein the second U-shaped member includes a second longitudinal flange extending laterally outwardly from an upper end of a corresponding second wall, and wherein the second securing member is used to press the second longitudinal flange against a bottom edge portion of the panel.

20. The apparatus of claim 1, wherein the longitudinal flange includes teeth that point downward to improve the securing of the panel to the substrate.
